(19) United States
(12) Patent Application Publication
(10) Pub. No.: US 2015/0294392 A1
(43) Pub. Date: Oct. 15, 2015

(54) SYSTEM AND METHOD FOR LOCATION BASED CLIENT SERVICE MANAGEMENT, IN A SERVICE PROVIDER'S FACILITY

(71) Applicants: IDO SHARON, ZUR HADASSA (IL); SAGIV GOREN, RAANANA (IL)

(72) Inventors: IDO SHARON, ZUR HADASSA (IL); SAGIV GOREN, RAANANA (IL)

(21) Appl. No.: 14/251,920

(22) Filed: Apr. 14, 2014

(51) Int. Cl. G06Q 30/06; H04W 4/02

(52) U.S. Cl. CPC G06Q 30/0633; H04W 4/02; G06Q 50/12

(57) ABSTRACT

System and method for location based client service management. The location based client service management may include detecting presence of a smart device of a user at a specific point of service within an establishment, providing a location based service to the user via the smart device, obtaining an order from the user via the smart device, and linking the order to the specific point of service in which the smart device was detected.

### BACKGROUND OF THE INVENTION

A diner in a restaurant needs to be seated, wait for the waiter, make an order, and only then his order is being prepared. This procedure may be time consuming, wasting the time of both the diner and the restaurant. Turnover time may be a critical factor affecting how many diners the restaurant can serve at a given time, and consequently, may affect the revenues of the restaurant.

Systems for obtaining orders electronically, in which users make orders through their smart devices are known. However current systems don't provide the restaurant with precise location information. Thus the waiter may not know where the courses should be served to. Also known are electronic devices that are connected to a management server of the restaurant and are attached to the restaurant tables or are embedded in the restaurant tables. Diners can make orders via these electronic devices and these orders are immediately transferred to the management server. However, these systems are typically expensive. Additionally, it is hard to keep these electronic devices clean enough in a dining area. Consequently, many diners refrain from using the common electronic devices due to hygiene considerations.

### SUMMARY OF THE INVENTION

According to embodiments of the present invention, there is provided a method for location based client service management, the method may include: detecting presence of a smart device of a user at a specific point of service within an establishment; providing a location based service to the user via the smart device; obtaining an order from the user via the smart device; and linking the order to the specific point of service in which the smart device was detected.

Furthermore, according to embodiments of the present invention, detecting the presence of the smart device at the specific point of service may include reading by the smart device a location code that is associated with the specific point of service.

Furthermore, according to embodiments of the present invention, location code may be included in a location identifier, wherein the location identifier may include at least one of a barcode, quick response (QR) code, near field communication (NFC) device, unpowered NFC tag and frequency identification (RFID) tag.

Furthermore, according to embodiments of the present invention, the establishment maybe a business that serves meals or refreshments, the specific point of service may be a table at the establishment or a seat at the establishment. The location identifier of a specific table may be attached to the table.

Furthermore, according to embodiments of the present invention, the method may include billing the user via the smart device.

Furthermore, according to embodiments of the present invention, the method may include obtaining payment from the user via the smart device.

According to embodiments of the present invention, there is provided a device for providing location based client service management, the device may include a processor configured to: obtain a location code from a smart device of a user; associate the location code to a specific point of service at a specific establishment; provide a location based service to the user via the smart device; obtain an order from the user via the smart device; and link the order to the specific point of service.

According to embodiments of the present invention, there is provided a system for providing location based client service management, the system may include: a plurality of location indicators, each may include a unique location code and each may be installed in a location corresponding to a specific point of service within at least one establishment; and a processor configured to: obtain a location code from a smart device of a user, the location code is one of the unique location codes corresponding to one of the plurality of location indicators; and associate the location code to a specific point of service at a specific establishment.

Furthermore, according to embodiments of the present invention, the processor may be configured to: provide a location based service to the user via the smart device; obtain an order from the user via the smart device and link the order to the specific point of service.

Furthermore, according to embodiments of the present invention, the processor may be further configured to bill the user via the smart device.

Furthermore, according to embodiments of the present invention, the processor may be further configured to obtain payment from the user via the smart device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a high-level diagram of an exemplary system for location based client service management according to embodiments of the present invention;

FIG. 2A presents an exemplary arrangement of location identifiers according to embodiments of the present invention;

FIG. 2B presents a second exemplary arrangement of location identifiers according to embodiments of the present invention;

FIG. 3 is a flowchart illustration of a method for location based client service management according to embodiments of the present invention;

FIG. 4 is a flowchart illustration of a method for registration to a location based client service management according to embodiments of the present invention;

FIG. 5 is a flowchart illustration of a method for providing a location based service and taking an order according to embodiments of the present invention; and

FIG. 6 is a flowchart illustration of a method for billing a user according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the present invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the present invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

Embodiments of the present invention may provide a system and method for location based client service management, that may enable detecting presence of a smart device of a user at a specific point of service within an establishment (e.g. a specific location within the service provider's establishment, where the service should be provided), providing a location based service to the user via the smart device and obtaining an order from the user via the smart device and linking the order to the specific point of service in which the smart device was detected. According to embodiments of the present invention, the interface to the user may include mainly the smart device of the user. Thus, the user may not have to touch or activate any devices provided by or present at the establishment, which many users find unpleasant due to various reasons including hygiene considerations.

As used herein, an establishment may refer to any business or organization that may offer goods and services to customers at a specific physical location within the establishment. The specific physical location of the smart device (and hence of the client) is referred to herein as the specific point of service. For example, the establishment may be a restaurant that serves food and drinks to diners, in which case the specific point of service is the place where the food should be served to, e.g., the table at which the diner sits or even the specific location around a table where the diner sits. The establishment may also include sport stadiums, airplanes, trains etc., in which people sit and may be served food and other goods at their seats, or shops where shoppers may be served at a specific department. etc.

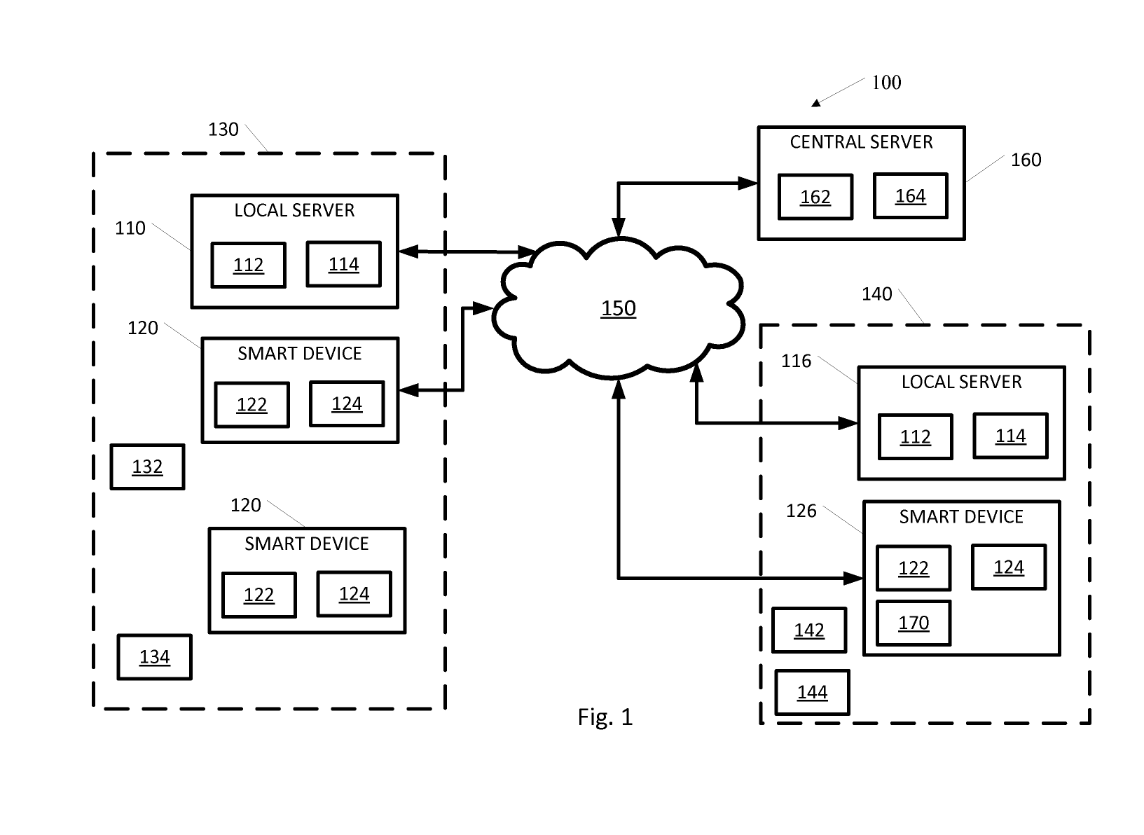

Reference is made to FIG. 1 which is a high-level diagram of an exemplary system 100 for location based client service management according to embodiments of the present invention. According to embodiments of the present invention, system 100 may include central server 160, at least one local server 110, 116 and a plurality of smart devices 120, 126. At least one local server 110, 116 and the plurality of smart devices 120, 126 and central server 160 may be configured to communicate via communication network 150.

Central server 160 may include processor 162 and memory unit 164. Processor 162 may be configured to execute commands included in a program, algorithm or code stored in memory 164. Processor 162 may be any computation device that is configured to execute various operations included in some methods disclosed herein. Memory 164 may be a non-transitory computer-readable storage medium that may store thereon instructions that when executed by processor 162, cause processor 162 to perform operations and/or methods, for example, some of the methods disclosed herein.

Each of local servers 110, 116 may include a processor 112 and a memory unit 114. Processor 112 may be configured to execute commands included in a program, algorithm or code stored in memory 114. Processor 112 may be any computation device that is configured to execute various operations included in some methods disclosed herein. Memory 114 may be a non-transitory computer-readable storage medium that may store thereon instructions that when executed by processor 112, cause processor 112 to perform operations and/or methods, for example, some of the methods disclosed herein. Each of local servers 110, 116 may be configured to give local services to an establishment 130, 140, and may reside in the establishment 130, 140 or may be otherwise connected to the establishment 130, 140, e.g., as a cloud service. In the example presented in FIG. 1, local server 110 may give local services to establishment 130 and local server 116 gives local services to establishment 140.

Each of smart devices 120, 126 may include a processor 122 and a memory unit 124. Processor 122 may be configured to execute commands included in a program, algorithm or code stored in memory 124. Processor 122 may be any computation device that is configured to execute various operations, for example in the form of applications, the operations included in some methods disclosed herein. Memory 124 may be a non-transitory computer-readable storage medium that may store thereon instructions that when executed by processor 122, cause processor 122 to perform operations and/or methods, for example, some of the methods disclosed herein. Smart devices 120, 126 may be configured to communicate with central server 160 and/or local server 110, 116 via network 150. Examples of smart devices may include mobile phones, portable computers, laptop computers, tablet computers, notebook computers, handsets, personal digital assistants (PDAs) etc. Optionally, smart devices 120, 126 may include a Near Field Communication (NFC) module 170 (shown for smart device 126, although may be included in any other smart device of system 100). NFC module 170 may enable exchange of data between smart devices 120, 126 and other NFC devices, or reading of NFC tags or Radio Frequency Identification (RFID) tags over short distances (up to approx. 10 centimeters).

Each of processors 162, 112, 122 may include components such as, but not limited to, one or more Central Processing Units (CPU) or any other suitable multi-purpose or specific processors or controllers, one or more input units, one or more output units or any other suitable hardware components and/or software components.

System 100 may include a plurality of location identifiers 132, 134, 142, 144. Location identifiers 132, 134, 142, 144 may be located at, or otherwise related, associated or linked to, specific points of service within an establishment. In the example presented in FIG. 1, location identifiers 132, 134 are linked to specific points of service within establishment 130, while location identifiers 142, 144 are linked to specific points of service within establishment 140.

Each of location identifiers 132, 134, 142, 144 may include a location code that is associated with a point of service. The location code of location identifiers 132, 134, 142, 144 may be unique to each location identifier. The location code of location identifiers 132, 134, 142, 144 may be included in barcodes or Quick Response (QR) codes that are readable and recognizable by smart devices 120, 126. Additionally or alternatively, location identifiers 132, 134, 142, 144 may include Bluetooth transmitters, NFC devices, unpowered NFC tags, or RFID tags having an identification number (referred to herein as NFC ID). The barcodes, QR codes or NFC IDs, of location identifiers 132, 134, 142, 144 may include the unique location code for that location identifier. Alternatively or as a backup, location identifiers 132, 134, 142, 144 may present the location code to the user, which may type it into his smart device. The association of the location codes of location identifiers 132, 134, 142, 144 to the specific points of service may be known to system 100. When a smart device, e.g., smart device 120, reads the barcodes, QR codes or the NFC IDs of a specific location identifier, e.g., location identifier 132, smart device 120 may obtain the location code of location identifier 132 and may forward the location code to other components of system 100, such as central server 160 or local servers 110, 116. Thus, system 100 may know the point of service of smart device 120, and hence of the client using smart device 120.

Additionally or alternatively, location identifiers 132, 134, 142, 144 may include a biometric identification device that may identify a user that is present at a point of service that is related with or recognizable by location identifiers 132, 134, 142, 144. Location identifiers 132, 134, 142, 144 may send the identity information to central server 160 or local servers 110, 116 that may activate the relevant application in smart devices 120, 126 and provide the location based service as described herein. The biometric identification device may utilize any applicable biometric identification method. For example, location identifiers 132, 134, 142, 144 may include a camera and processing means that may capture and identify the face, the iris, the fingerprint, etc., of the user. Alternatively, location identifiers 132, 134, 142, 144 may include a camera that may capture the relevant image (e.g., the face, the iris, the fingerprint etc.,) and may forward the image to central server 160 or local servers 110, 116 for identification.

According to embodiments of the present invention, system 100 may be managed by a central server 160, that may work in conjunction with local servers 110, 116, each of local servers 110, 116 may be local to one establishment. According to other embodiments, central server 160 may not be required and system 100 may be managed locally for each establishment, by one of local servers 110, 116. For example, after reading the location code of location identifier 132, smart device 120 may send the location code of location identifier 132, to either central server 160 or to the local server that is related to the establishments 130 that location identifier 132 is related to, e.g., local server 110, or to both. One of central server 160 or local server 110, depending on system configuration, may provide a location based service to the user via the smart device. The service may include presenting a menu to the user, enabling communication with a human service provider, etc. For example, central server 160 may include databases that relate each of location identifiers 132, 134, 142, 144 to a specific establishment 130, 140, or to a specific location within establishments 130, 140, and a database that includes all services that may be provided to each specific point of service. When central server 160 receives an indication from smart device 120 that smart device 120 is present in the specific point of service related to location identifier 132, central server 160 may send or activate at smart device 120, the location based services that are fitted to that location at establishment 130. Optionally, central server 160 may adjust or personalize the location based services according to previously received user preferences. For example, server 160 may remove from a menu, or add a mark to courses that the user doesn't like or that contain ingredients that the user is allergic to. According to another example, recommendations to specific courses may be presented to the user, based on previous orders and user defined criteria such as, low fat courses, vegetarian courses and the like.

The user may select items from the menu presented to him or may otherwise make an order via his smart device. The order may be sent to either central server 160, local server 110 or to both, depending on system configuration. Since the specific point of service of the user is known, the order may be linked to that specific point of service. The order together with the specific point of service to which it should be supplied may be presented to the human service provider. Hence, the service provider may know which items to provide to which location. For example. If the establishment is a restaurant, the waiter may know which courses to serve to which seat or table. To complete the process, the user may be billed directly to his smart device 126, and may pay via smart device 126. The billing and payment may be performed by either central server 160 or local server 110, depending on system configuration. Embodiments of the present invention are not limited to a specific billing and payment methods and other billing and payment methods may apply.

According to embodiments of the present invention, network 150 may be, may include, or may be part of a private IP network, the internet, an integrated services digital network (ISDN), a set of frame relay connections, a public or private data network, a Local Area Network (LAN), a Wide Area Network (WAN), a wireline or wireless network, a local, regional, or global communication network, an enterprise intranet, any combination of the preceding and/or any other suitable communication infrastructure. It will be recognized that embodiments of the invention are not limited by the nature, type or other aspects of network 150.

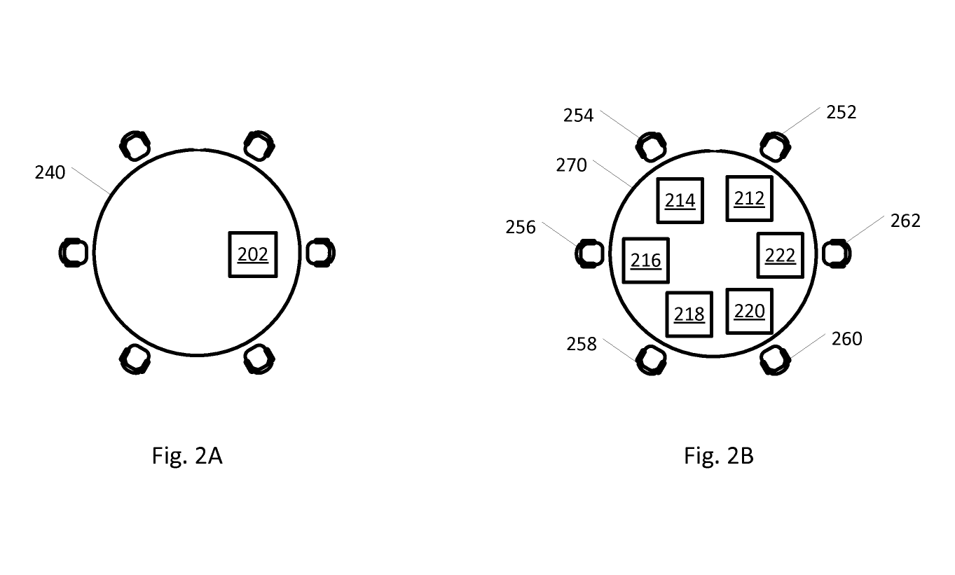

Reference is now made to FIGS. 2A and 2B which present exemplary arrangements of location identifiers according to embodiments of the present invention. In FIG. 2A a specific point of service may be defined as a specific table at an establishment, thus a single location identifier 202 may be given to table 240. In FIG. 2B a specific point of service may be defined as a specific seat at a table of an establishment, thus a single location identifier 212, 214, 216, 218, 220, 222 may be given to each seat (or location) 252, 254, 256, 258, 260, 262, respectively, around table 270.

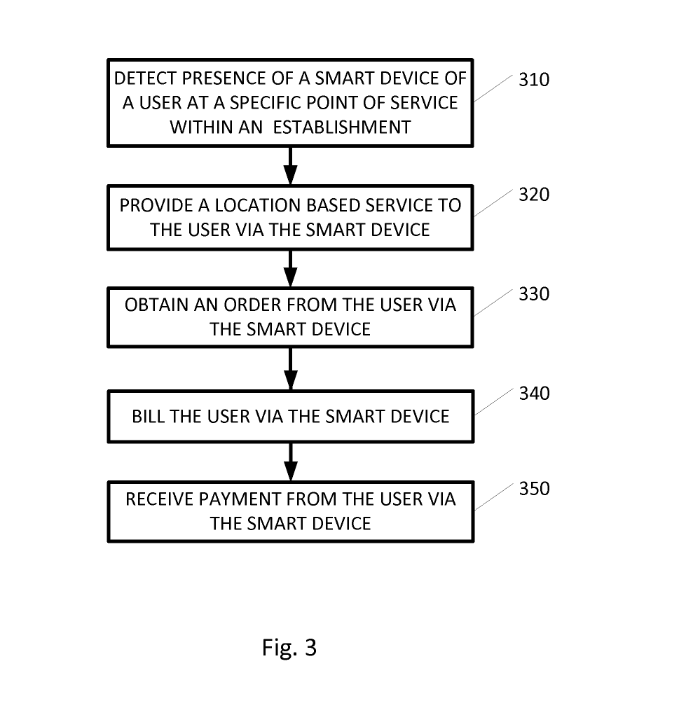

Reference is now made to FIG. 3 which is a flowchart illustration of a method for location based client service management according to some embodiments of the present invention. Operations of the method may be implemented by, for example, system 100 of FIG. 1 and/or by other suitable units, devices, and/or systems.

In operation 310 presence of a smart device, e.g., smart device 126, of a user at a specific point of service within an establishment, e.g., establishment 130, is detected. According to embodiments of the present invention, each point of service of the establishment is associated or linked with a specific location code that may be embedded in a location identifier, such as a barcode, QR code, NFC tag or RFID tag. When a user is present at the point of service he may place his smart device in close proximity with the location identifier that is associated or linked with his point of service, e.g., location identifier 132. The smart device of the user may be configured to read the location code of the location identifier and thus obtain the location code of the point of service. The smart device may be further configured to send the location code to a server, for example, to a central server or to a local server of the establishment.

In operation 320 a location based service is provided to the user via his smart device. The location based service may be specific to the establishment or to the specific point of service of the user. For example, the location based service may include presenting the menu of the restaurant to the user and enabling the user to make an order out of the menu. If the restaurant includes more than one dining room, each with a different menu, the right menu may be presented to the user according to his specific point of service. The location based service may include enabling the user to communicate with a human service provider, e.g., a waiter of the restaurant, via any applicable communication channel, such as chat or a voice communication channel.

In operation 330 an order is obtained from the user via his smart device. According to embodiments of the present invention, the order may be linked to the specific point of service in which the smart device was detected. The order together with an indication of the specific point of service in which the smart device was detected may be presented to a human service provider. Hence, the service provider may be informed of the order and the specific point of service where the goods should be brought to. For example, a waiter in a restaurant may be informed of the specific items a user has selected, and of the user seat or table to which this order should be supplied.

In operation 340 a bill may be sent to the user via his smart device and in operation 350 the user may pay for his order via his smart device. It should be noted that embodiments of the present invention are not limited to a specific billing and payment methods and that other billing and payment methods may be used.

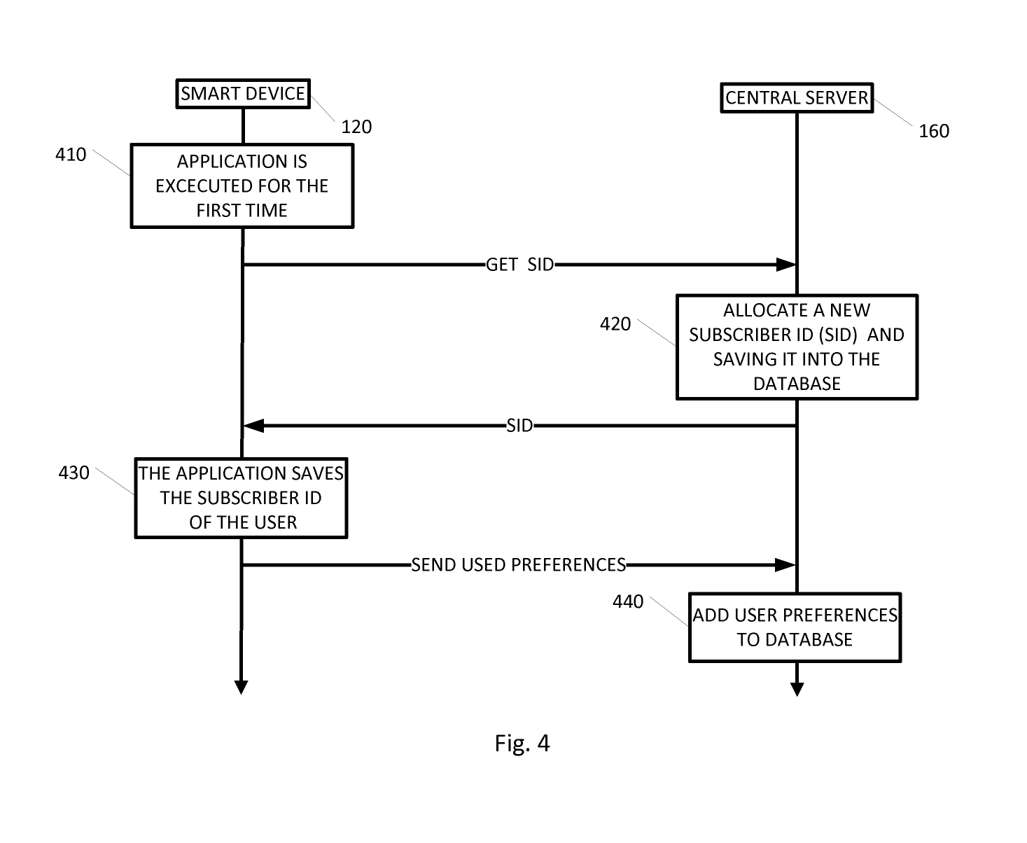

Reference is now made to FIGS. 4, 5 and 6 present flowchart illustrations of an exemplary implementation of embodiments of the present invention that may be performed by, for example, components of system 100 of FIG. 1 and/or by other suitable units, devices, and/or systems. These examples are non binding. It should be readily understood by these skilled in the art that other pacific implementations and system designs are possible. For example, some actions performed by central server 160 in the following example may be performed by a local server 110, or by smart device 120, and vice versa.

FIG. 4 is a flowchart illustration of a method of registration to a location based client service management system according to embodiments of the present invention. According to embodiments of the present invention, smart device 120 may be configured to execute various operations, for example in the form of an application. In operation 410 the application may be executed for the first time. For example, the user of smart device 120 may download the application and open it for the first time. As a result, smart device 120 may request a Subscriber Identification Number (SID) from central server 160. In operation 420 central server 160 may allocate a new SID, save the new SID in a subscriber database and send the SID to smart device 120. In operation 430 the application may save the SID of the user. Optionally the user may send to central server 160 user preferences, including, for example, types of food the used doesn't like or is allergic to. In operation 440 user preference data is stored, for example, in the subscriber database together with the user SID.

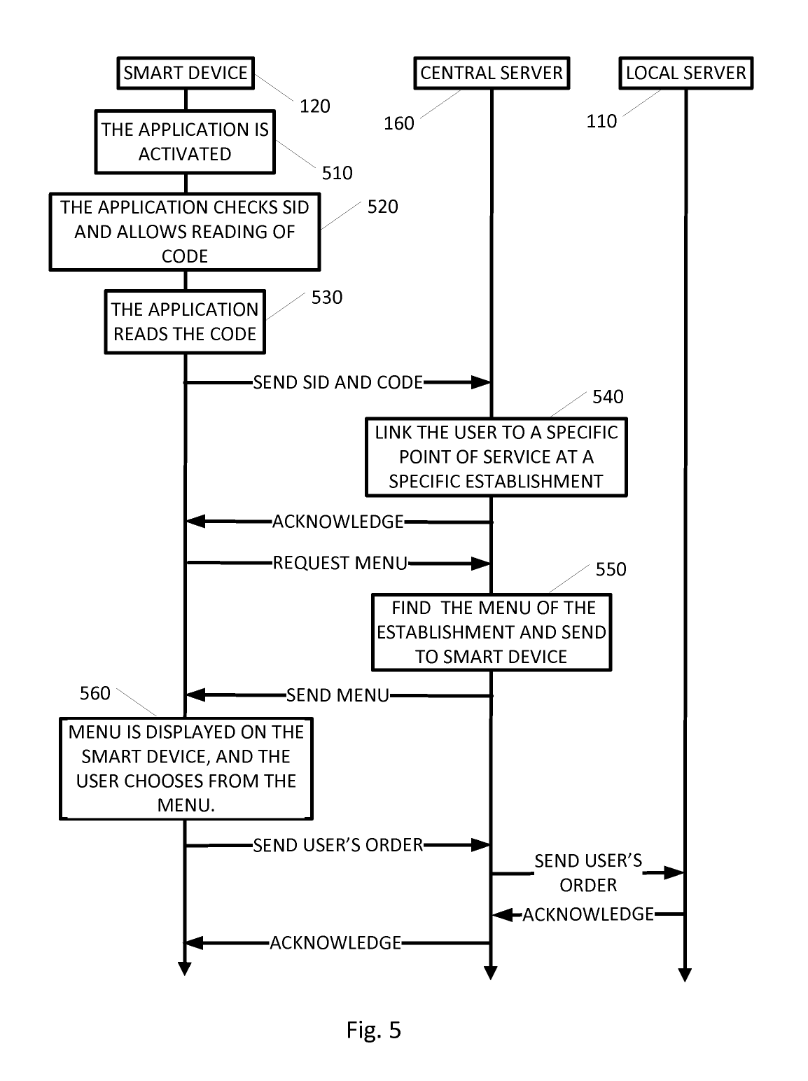

Reference is now made to FIG. 5 which is a flowchart illustration of a method for providing a location based client service and taking an order, according to embodiments of the present invention. In operation 510 the application may be activated. In optional operation 520 the application may check the SID and if properly registered, enable reading of a location code. In operation 530 the application may read a location code, for example, location code of location identifier 132. The application may send the location code to central server 160. Central server 160 may obtain the location code and, based on the location code and on information stored in databases of central server 160, may link the SID of the user to the specific point of service of the specific establishment 130 that location identifier 132 is associated with. Central server may acknowledge to smart device 120 that the specific point of service of smart device 120 is recognized. In response, smart device 120 may request central server 160 to send the menu of establishment 130 to smart device 120. In operation 550 central server 160 may find the menu of establishment 130 and send it back to smart device 120. Optionally, central server 160 may adjust or personalize the menu according to the user preferences. For example, server 160 may remove from the menu, or add a mark to courses that the user doesn't like or that contain ingredients that the user is allergic to. In operation 560, the menu may be displayed on smart device and the user may enter his choice or order, to smart device 120. Next, the order may be sent to central server 160, which may send it to local server 110 of establishment 130. Local server 110 may acknowledge central server 160 that may acknowledge to smart device 120 that an order form a user that is located in a specific point of service has been obtained.

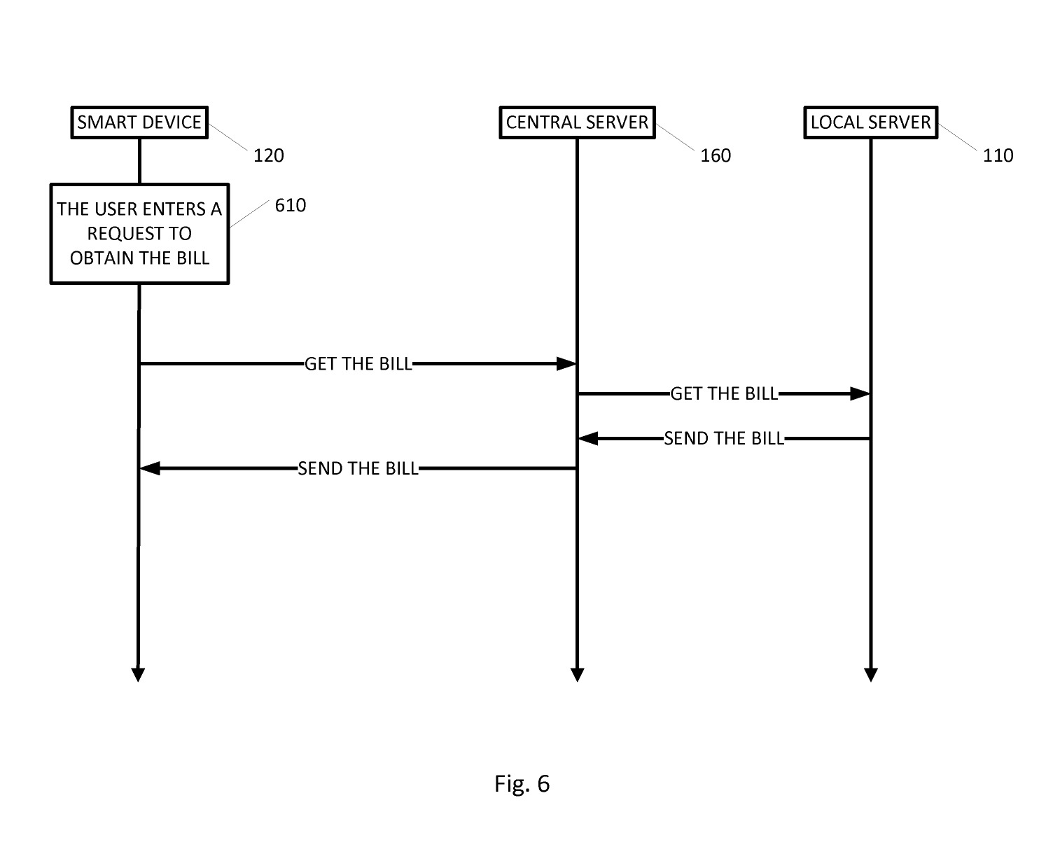

Reference is now made to FIG. 6 which is a flowchart illustration of a method for billing a user according to embodiments of the present invention. In operation 610 the user may enter into the application a request to obtain the bill. The request may be sent to central server 160, which may forward it to local server 110, which may send the bill to central server 160 which may forward it to smart device 120.

When utilizing barcodes, QR codes, NFC devices, unpowered NFC tags, or RHD tags for identification, the user has to actively place his smart device in close proximity with location identifiers 132, 134, 142, 144. Thus, an active and intentional cooperation of the user is required. This may have the advantage of preventing a variety of privacy issues and concerns that may arise by users and authorities when using other location identification methods, especially considering that the process disclosed herein requires location identification in conjunction with personal identification.

Some embodiments of the present invention may be implemented in software for execution by a processor-based system, for example, central server 160, local servers 110 116, and smart devices 120, 126. For example, embodiments of the present invention may be implemented in code or software and may be stored on a non-transitory storage medium having stored thereon instructions which, when executed by a processor, cause the processor to perform methods as discussed herein, and can be used to program a system to perform the instructions. The non-transitory storage medium may include, but is not limited to, any type of disk including floppy disks, optical disks, compact disk read-only memories (CD-ROMs), rewritable compact disk (CD-RW), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices. Other implementations of embodiments of the present invention may comprise dedicated, custom, custom made or off the shelf hardware, firmware or a combination thereof.

Embodiments of the present invention may be realized by a system that may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for location based client service management, the method comprising:
detecting presence of a smart device of a user at a specific point of service within an establishment;
providing a location based service to the user via the smart device;
obtaining an order from the user via the smart device; and
linking the order to the specific point of service in which the smart device was detected.

2. The method of claim 1, wherein detecting the presence of the smart device at the specific point of service comprises reading by the smart device a location code that is associated with the specific point of service.

3. The method of claim 2, wherein the location code is included in a location identifier, wherein the location identifier comprises at least one of a barcode, quick response (QR) code, near field communication (NFC) device, unpowered NFC tag and frequency identification (RFID) tag.

4. The method of claim 1, wherein the establishment is a business that serves meals or refreshments.

5. The method of claim 4, wherein the specific point of service is a table at the establishment.

6. The method of claim 5, wherein the location identifier of a specific table is attached to that table.

7. The method of claim 4, wherein the specific point of service is a seat at the establishment.

8. The method of claim 1, comprising billing the user via the smart device.

9. The method of claim 8, comprising obtaining payment from the user via the smart device.

10. A device for providing location based client service management, the device comprising:
a processor configured to:
obtain a location code from a smart device of a user;
associate the location code to a specific point of service at a specific establishment;
provide a location based service to the user via the smart device;
obtain an order from the user via the smart device; and
link the order to the specific point of service.

11. A system for providing location based client service management, the system comprising:
a plurality of location indicators, each including a unique location code and each installed in a location corresponding to a specific point of service within at least one establishment; and
a processor configured to:
obtain a location code from a smart device of a user, the location code is one of the unique location codes corresponding to one of the plurality of location indicators; and
associate the location code to a specific point of service at a specific establishment.

12. The system of claim 11, wherein the processor is configured to:
provide a location based service to the user via the smart device;
obtain an order from the user via the smart device; and
link the order to the specific point of service.

13. The system of claim 11, wherein each of the location identifiers comprises at least one of a barcode, quick response code, near field communication (NFC) device, unpowered NFC tag and frequency identification (RFID) tag.

14. The system of claim 12, wherein the establishment is a business that serves meals or refreshments.

15. The system of claim 14, wherein the specific point of service is a table at the establishment.

16. The system of claim 15, wherein the location identifier of a specific table is attached to that table.

17. The system of claim 14, wherein the specific point of service is a seat at the establishment.

18. The system of claim 17, wherein the location identifier of a specific seat is located in close proximity with the seat.

19. The system of claim 12, wherein the processor is further configured to bill the user via the smart device.

20. The system of claim 12, wherein the processor is further configured to obtain payment from the user via the smart device.
